(19) United States
(12) Patent Application Publication
(10) Pub. No.: US 2004/0180654 A1
(43) Pub. Date: Sep. 16, 2004

(54) Multiple alerting

(76) Inventor: Ben-Ren Chen, Northborough, MA (US)

Correspondence Address: MCDERMONT, WILL & EMERY, 600 13th Street, N.W., Washington, DC, 20005-3096, US

(21) Appl. No.: 10/744,135

(22) Filed: Dec. 24, 2003

Related U.S. Application Data
(60) Provisional application No. 60/437,011, filed on Dec. 31, 2002.

(51) Int. Cl. H04Q 7/20

(52) U.S. Cl. 455/433; 455/412.2; 455/428

(57) ABSTRACT

The disclosed multiple alerting service, provided through a mobile communication network, is controlled by the subscriber's home location register (HLR) and/or the mobile switching center (MSC) provisioned as the home MSC for the pilot number. A call to the pilot number triggers access of the subscriber record in the HLR, and the home MSC launches call legs to the subscriber's mobile station and one or more member numbers. An alternate available member number may be substituted, for example, if a station of one of the initial numbers is unavailable. If a call leg is answered, the home system completes the call to that leg and releases the other call leg(s). If completion to a group station is not possible, the home system redirects the call to an alternate termination, based on the subscriber's record, for example, to a voice mailbox associated with the pilot number in the home system.

### RELATED APPLICATIONS

This application claims the benefit of U.S. Provisional Application No. 60/437,011 filed by Ben-Ren Chen on Dec. 31, 2002, entitled “MULTIPLE ALERTING,” the disclosure of which is entirely incorporated herein by reference.

### TECHNICAL FIELD

The present subject matter relates to a technique for providing call alerting, that is to say notification of an incoming call, to a number of potential answering destinations, for mobile communication service users.

### BACKGROUND

Many new communications devices and related services have emerged, to allow people to communicate freely as they roam, without the need for a fixed network connection. In particular, modem digital public wireless telephone networks offer customers a wide range of voice and data communication services combined with a high degree of mobility.

Multiple alerting is a call termination feature. When someone calls a pilot number of a multiple alerting subscriber, the feature causes the call to branch into multiple legs. The first leg to result in an answer will be connected to the calling party. The other call legs will be abandoned. Although originally developed for landline telephone customers, multiple alerting has been extended to services for customers using mobile or wireless telecommunication devices, typically cellular or PCS (personal communication service) type telephone stations. Examples of earlier multiple alerting proposals are contained in the several US patents, as summarized below.

U.S. Pat. No. 6,009,159 to Baiyor et al. Dec. 28, 1999 discloses a technique for controlling the start of alerting of multiple leg telecommunication sessions, such as for providing concurrent alerting of outgoing call legs for a flexible alerting service. The preferred system includes a home location register coupled to a mobile switching center. The home location register stores a plurality of secondary directory numbers in association with a primary directory number, such as an ANSI compatible pilot directory number. For each secondary directory number, further stores a corresponding timing delay parameter. The mobile switching center has an interface for receiving an incoming call leg designating the primary directory number and for differentially processing and routing each outgoing call leg associated with each secondary directory number, of the secondary directory numbers, according to its corresponding timing delay parameter.

U.S. Pat. No. 6,115,461 to Baiyor et al. discloses a related technique for providing information to a called party of multiple leg telecommunication sessions, such as in a flexible alerting service. The mobile switching center differentially processes and routes each outgoing call leg associated with each secondary directory number. The mobile switching center further provides, in each outgoing call leg, first called party information distinguishing each outgoing call leg as a multiple leg telecommunication session. A waiting signal is provided to called parties, such as a steady, audible tone.

U.S. Pat. No. 6,366,660 to Baiyor et al. discloses a technique for providing variable alerting patterns for multiple leg telecommunication sessions, such as for providing concurrent alerting, sequential alerting, pyramid alerting or cascade alerting, of outgoing call legs for a flexible alerting service. The system includes a home location register coupled to a mobile switching center. The home location register has, stored in a memory, a plurality of secondary directory numbers associated with a primary directory number, such as an ANSI compatible pilot directory number. For each secondary directory number, the HLR memory also stores a corresponding timing delay parameter, a corresponding “no answer” time parameter, and a corresponding “no answer” termination trigger. Variation of the various corresponding timing delay parameters and “no answer” time parameters produces the variable alerting patterns. The mobile switching center has an interface for receiving an incoming call leg designating the primary directory number and for differentially processing and routing each outgoing call leg associated with each secondary directory number, according to its corresponding timing delay parameter, to form a plurality of outgoing call legs; and unless an outgoing call leg of the plurality of outgoing legs has been answered, for alerting each outgoing call leg for a time period of its corresponding “no answer time” parameter. Upon an expiration of the time period, the system treats each outgoing call leg according to its corresponding no answer termination trigger.

U.S. Pat. No. 6,005,930 to Baiyor et al. discloses a similar technique for controlling secondary treatment by a distant switch for multiple leg telecommunication sessions, such as for providing secondary treatment of outgoing call legs for a flexible alerting service, by an originating switch rather than a distant or terminating switch. In this technique, each corresponding originating “no answer” time parameter, for each outgoing call leg, is less than a corresponding terminating no answer time parameter which may be utilized by a terminating switch or end office.

U.S. Pat. No. 5,475,748 to Jones describes an automated call processing system for telephone networks and more particularly an automated call processing system for locating a called party. The system utilizes either sequential or simultaneous outdialing. In the sequential method an incoming caller indicates special handling desired to reach a called party. A plurality of outdialing operations is then performed in sequence, terminating each unsuccessful outdialing operation when the called party is unavailable at the corresponding number. When the called party is contacted by a successful outdialing operation, the incoming caller is connected to the called party. In the sequential process the caller is informed of the progress of outdialing operations and is notified when each outdialing fails. The caller is given an opportunity to continue with the next set or substitute a different number for dialing, leaving a message on voice mail, sending a facsimile or E-mail, etc. In the simultaneous method the outdialing operations are initiated simultaneously.

U.S. Pat. No. 5,206,901 to Harlow et al. describes a system for alerting a plurality of telephones in response to an incoming call to a destination directory number. A handling switch sends a query to a centralized database requesting routing instructions, and the database returns the directory numbers of the telephones to be alerted for incoming calls to the destination directory number. The busy/idle status of all of the telephones is checked, and an alerting signal is sent to all idle telephones. The handling switch is notified as to which alerted telephone has an off-hook appearance first, and the incoming call is routed to that telephone.

U.S. Pat. No. 5,815,563 to Ardon relates to a telecommunication system with remote call pick-up capabilities. Remote call pick-up is provided for analog telephones. Upon receiving a call request for first analog customer premises equipment (CPE), a first record associated with the first CPE is read. The record contains a directory number for a second analog CPE. The first CPE is rung with a standard ring pattern and the second CPE is concurrently rung with an alternate ring pattern signifying that the second CPE is not the original call destination. The call is completed to the second CPE if a remote call pick-up code is received from the second CPE before the first CPE goes off-hook.

U.S. Pat. No. 5,815,562 to Iglehart et al. teaches providing a user with one telephone number that rings phones on heterogeneous systems worldwide. A server allows a worldwide telephone number associated with a local telephone to be shared by one or more remote telephones. A call placed to the worldwide telephone number rings at the local telephone and at least one of the remote telephones. The server stores a set of telephone numbers to be associated with a worldwide telephone number serviced by the switch to which the local telephone is connected. The server receives notification of a telephone call from a calling telephone to the worldwide telephone number. The server retrieves the set of telephone numbers associated with that worldwide telephone number, and places calls to telephone numbers in the set through the switch. The server then causes a connection to be made between the calling telephone and either the local telephone or the remote telephone, depending on which telephone goes off hook first, for example, by causing the switch to make a conference call connection between the calling telephone and the remote telephone.

U.S. Pat. No. 5,802,160 Kugell et al. also discloses a multi-ring telephone service, which involves associating a list of telephone numbers with a representative telephone number. A call to the representative telephone number is detected, and the network rings stations for a plurality of telephone numbers on the list. Signaling is terminated at at least one of the plurality of telephone numbers, thereby allowing a connection to a party at one of the telephone numbers. Each telephone number on the list may be a representative number, which is associated with another list of telephone numbers.

In a mobile communication implementation, the mobile station of the called party, i.e. the station normally associated with the primary number, may roam freely from its home serving area to visit other areas. When a call comes in, the station may be served by its home switch or by a remote switch. Many of the proposed systems, which can handle mobile services, require enhanced operations by both the home switch and the visited switch. To implement such arrangements, however, is difficult because the remote switches are often owned and operated by other carriers who may or may not upgrade their networks in a manner compatible with the multiple alerting service offered by the home switch. Hence, one need is for a technique that provides home system control of multiple alerting, without requiring remote servicing systems to implement any particular upgrades.

As with many modem telecom services, conditions arise when incoming calls are not successful. The patents mentioned above give little if any consideration to the criteria that should be used to decide if a group alerting call is unsuccessful or to the treatment that should be provided to the caller if a group alerting call is unsuccessful. Among those that do give any consideration to these issues, the only failure condition given any attention in the disclosed techniques seems to be the “no answer” condition. Among those patents that do give consideration to this issue, only one patent, U.S. Pat. No. 6,005,930, gives any consideration to home system control, and the mechanism proposed by that patent for home system control is seriously limited and highly undesirable.

U.S. Pat. No. 6,005,930 proposes home system control of the treatment provided in the “no answer” condition be achieved by including a no answer time parameter for each group member to be alerted in the LocationRequest RETURN RESULT, with the value of this parameter being selected to be so short that the Home MSC would detect the “no answer” condition for the group member before the serving system detects the “no answer” condition. Unfortunately, there is no practical way for the home system to determine the no answer time used by each of the many serving systems that might be visited by the members of the multiple alerting group. Additionally, there are conditions other than “no answer” (such as “no page response”) that a serving system might treat as “no answer” and that might be detected by a serving system well before a true “no answer” condition could be detected. Setting the “no answer” time at the home system to be so short that “no answer” is always detected at the home system rather than at the serving system can only be done by setting the “no answer” time at the home system to a value that is so short that it interferes with the normal completion of the call deliver process.

Hence a need exists for a multiple alerting technique that provides effective processing when incoming call attempts are unsuccessful, and still provides the multiple alerting service in a manner that relies on control from the mobile customer's home system.

### SUMMARY

The concepts disclosed herein address one or more of the above noted problems and thereby provide an enhanced multiple alerting service through a mobile communication network.

For example, a method is disclosed for providing multiple alerting service through a mobile communication network. The method entails receiving call origination signaling, relating to a call for a pilot number of a multiple alerting group, at a mobile switching center (MSC) serving as a home MSC for the pilot number. A home location register (HLR) record associated with the pilot number is accessed, to obtain roaming location information of a mobile station that has been assigned the pilot number for its mobile identification number, as well as information regarding routing to at least one additional “member” number. The network launches a first call leg for the pilot number based on the obtained roaming location information, from the home MSC. The network also launches a second call leg from the home MSC for the member number, based on the obtained routing information. If an answer indication is received regarding one of the call legs, the method then involves completing the call from the home MSC to the answered leg and releasing the other one of the call legs. However, if completion to at least one of call legs is not possible, the method involves completing the call from the home MSC to an alternate termination in accord with a subscriber service record associated with the pilot number.

In disclosed examples of the method, the home system, typically the HLR and home MSC, control all aspects of the multiple alerting service. From the perspective of the terminating MSCs serving called stations or the telephone network serving any landline member stations, the legs of the call appear as normal calls originated by the home MSC. The home system also controls any alternate termination treatment. The alternate termination, e.g. routing to voice mail, may be triggered in response to a variety of conditions. Examples include busy condition of the mobile station assigned the pilot number, busy condition of all stations in the group, no answer, failed call routing, no page response, station not reachable and group not reachable.

The method and the mobile network programmed to implement the method thus support a multiple alerting service. With this service, the pilot number assigned to a subscriber station for the multiple alerting service is a mobile number, served by a home location register (HLR) of the subscriber's home mobile network. Hence, the pilot number is a mobile number. Another feature of the service is that the service supports at least one additional multiple alerting destination number (DN), as a member number, in the subscriber's multiple alerting group. Each additional multiple alerting or “member” DN can be a mobile DN, and each additional multiple alerting DN can be a wireline member DN. In response to any call to the pilot number, the mobile communication network provides simultaneous alerting signals to the mobile station and to up to a set number (e.g. three) of additional member DNs in the group. The multiple alerting service for the subscriber supports up to some higher number (e.g. five) of additional member DNs, and the HLR selects a next available member DN if any of the simultaneously alerted stations is busy or unreachable.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitation. In the figures, like reference numerals refer to the same or similar elements.

FIG. 1 is a simplified functional block diagram of an exemplary wireless communication network, which may implement a multiple alerting service.

FIG. 2 is a signal flow diagram of first example of a multiple alerting call process.

FIG. 3 is a table showing examples of transaction capability parameters, which may be used in the process of FIG. 2.

FIG. 4 is a table of additional parameters, which may be used in the process of FIG. 2.

FIG. 5 is a table of parameters that may be contained in a location request return result type message.

FIG. 6 is a table showing the parameters for a local termination.

FIG. 7 is a table showing the parameters for an inter-system termination.

FIG. 8 is a table showing the parameters for a public switched network (PSTN) termination.

FIG. 9 is a table listing termination trigger parameters.

FIGS. 10A and 10B together form a table of termination trigger values.

FIG. 11 shows the data populated into trigger setup in regard to multiple alerting services, for the multiple user case and for the single user case.

FIG. 12 is a signal flow diagram of another example of a multiple alerting call process, wherein the call results in a ‘busy’ determination with regard to one member station (for a single user service implementation).

FIG. 13 is a signal flow diagram of another example of a multiple alerting call process, wherein the call results in a ‘busy’ determination with regard to one member station (for a multiple user service implementation).

FIG. 14 is a signal flow diagram of another example of a multiple alerting call process, for a call originating from a station of a group member.

FIG. 15 is a signal flow diagram of another example of a multiple alerting call process, for a call from a station member to access the associated voice mail box.

FIG. 16 is a signal flow diagram of another example of a multiple alerting call process, wherein the call results in a ‘no answer’ determination with regard to one member station (for a single user service implementation).

FIG. 17 is a table showing the parameters that may be provided in a transfer-to-number request message.

FIG. 18 is a signal flow diagram of another example of a multiple alerting call process, wherein the call results in a ‘no answer’ determination with regard to one member station (for a multiple user service implementation).

FIG. 19 is a signal flow diagram of another example of a multiple alerting call process, wherein the call results in a ‘no answer’ determination, but with an associated member redirection.

### DETAILED DESCRIPTION

Multiple alerting is a call termination feature. When someone calls a pilot number of a multiple alerting subscriber, the feature causes a pilot number to branch into multiple legs. The first answer leg will be connected to the calling party. The other call legs will be abandoned.

For mobile customers, the pilot number needs to be a mobile number served by the home location register (HLR) in their home system(s). The HLR stores in a memory, one or more multiple alerting member numbers (secondary directory numbers) in association with the pilot directory number. The home mobile switching center (MSC) receiving the call for the pilot number accesses the mobile station's HLR and uses the data to process and route multiple outgoing call legs. The resulting outgoing call legs include a leg associated with the pilot number (mobile station) as well as a leg associated with each multiple alerting member number. Any of the multiple alerting member numbers could be wireless or wireline numbers. The examples of multiple alerting discussed below support both single user and multiple users. A multiple alerting group may be considered busy when one of the destinations is busy, or the multiple alerting group may be considered busy when all of the destinations is busy.

AIN treatment is used in the exemplary system 1 to control processing of the multiple alerting service, for example, to control disposition of calls that do not successfully result in an answer. Many modem implementations of mobile and landline telephone networks utilize Advanced Intelligent Network or “AIN” type call processing, for example, to facilitate roaming in mobile networks and/or to offer special service features. In an AIN type system, local and/or toll offices of the telephone network detect one of a number of call processing events identified as AIN “triggers.” An office which detects a trigger will suspend call processing, compile a call data message and forward that message via a common channel signaling (CCS) link to a database system, such as a Service Control Point (SCP). If needed, the SCP can instruct the central office to obtain and forward additional information. Once sufficient information about the call has reached the SCP, the SCP accesses its stored tables in its database to translate the received message data into a call control message and returns the call control message to the office of the network via CCS link. The network offices then use the call control message to continue processing of the particular call to completion. In a mobile network, for example, the HLR often is implemented in an SCP.

The detailed design for all scenarios (busy, no page response, no answer, routing failure, and non reachable) are included in the attached drawing sheets. The following is an outline of the features of the Flexible Alerting (FA) service, for customers of mobile/wireless telephone services. Flexible Alerting causes a call to the pilot number to branch into multiple legs. The first leg to get an answer will be connected to the calling party. The other call legs are abandoned. Features of the service include:

Pilot number shall be a mobile number served by the HLR;

Member destination numbers (DNs) can be wireless or wireline numbers;

Up to three member DNs will be alerted at the same time. Each Flexible Alerting supports up to five member DNs;

HLR shall select next available DN if any of the first three DNs is busy;

Flexible Alerting shall support distinctive alerting for digital mobiles;

When a station of a Flexible Alerting pilot number dials its own number or *86, the call shall be routed to Flexible Alerting voice mail service; and

Pilot number shall not be Flexible Alerting member DN.

Flexible Alerting is a call termination feature.

Flexible Alerting member list and its associated ring start delay shall be provisioned via normal HLR provisioning functions.

Flexible Alerting may be used as single user or multiple users.

Flexible Alerting takes precedence over Flexible Alerting-member in the event of redirection treatment. In such a case, the call is usually routed to Flexible Alerting voice mail for redirection treatment.

Call Detail Record (CDR) of Flexible Alerting call shall include;

Flexible Alerting call indication; and

Dialed number was connected to the calling party.

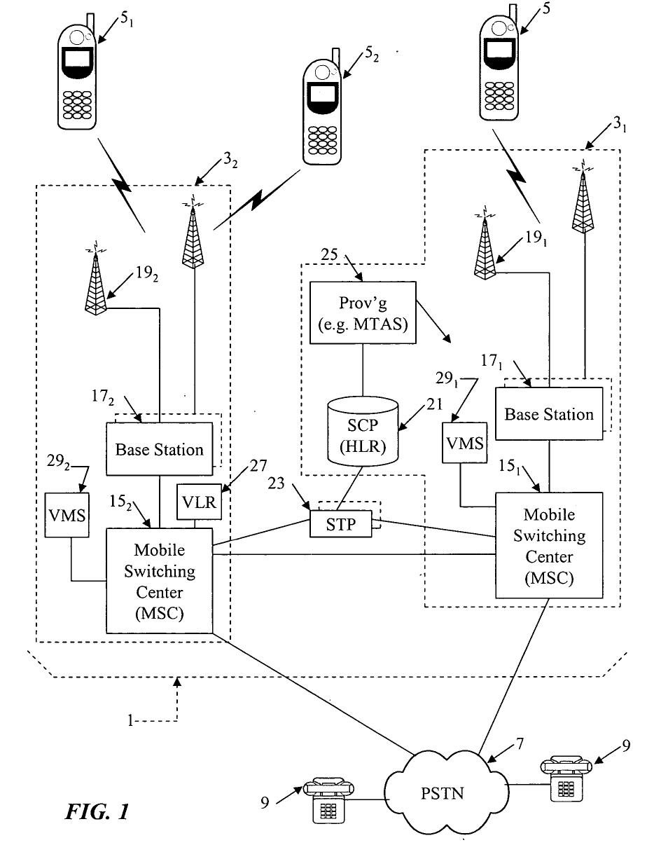

The multiple alerting service will be implemented in a wireless mobile communication network, such as that operated by a number of cellular service providers, though the mobile network(s) connect to a public landline network. Those skilled in the art are presumed to be familiar with the structure and operation of a wide variety of implementations of such telecom networks. However, for completeness of understanding a brief summary follows, with reference to FIG. 1.

FIG. 1 depicts a communication system 1 for providing voice telephone communications. As shown, the system 1 includes wireless communication networks 3 that provide wireless telephone or personal communications service (PCS) type services to mobile stations 5 depicted by way of example as mobile handsets in the different service areas. Each network 3 enables users of the mobile stations 5 to initiate and receive telephone calls to each other as well as through the public switched telephone network (PSTN) 7 to telephone devices 9. The networks 3 may also enable users of the mobile stations 5 to initiate and receive various data communications, for example via the public data network referred to as the Internet (not shown) to send or receive data from other digital devices. Each network 3 provides wireless communication services in accord with a digital protocol or an analog protocol or both.

Although shown as handset type mobile telephones, the stations 5 may take a variety of forms. For example, a mobile station 5 may be an enhanced mobile telephone station with a display and user input capabilities to support certain text and image communications, for example, for e-mail and web surfing applications, in addition to basic mobile telephone services. Another mobile station 5 may comprise a PDA (portable digital assistant) with built-in wireless communication capabilities. As another alternative, a portable computer (e.g. handheld or laptop) may incorporate a wireless transceiver device to enable communications through the network. For the multiple alerting service, the station 5 need only be capable of communication via the network(s) and of receiving and answering the alert signaling for an incoming call.

Each regional network 3 includes a mobile switching center (MSC) 15. Each MSC 15 connects through trunk circuits to a number of base stations 17, which the respective MSC controls.

The base station or base transceiver system (BTS) at 17, is the part of the radio network 3 that sends and receives RF (radio frequency) signals to/from the mobile stations 5 that the base station currently serves. The base station 17 connects to and communicates through the antenna systems on a radio tower 19. The base station 17 contains the transmitters and receivers at a site and is responsible for the control, monitoring, and supervision of calls made to and from each mobile station 5 within its serving area, over the wireless air link. The base station 17 assigns and reassigns channels to the mobile stations and monitors the signal levels to recommend hand-offs to other base stations.

Each network 3 typically includes a base station controller (BSC) functionality that controls the functions of a number of base stations 17 and helps to manage how calls made by each mobile station 5 are transferred (or “handed-off”) from one serving base station 17 to another. Each wireless network equipment vender implements this function differently. Some vendors have a physical entity, which they call a BSC, while other vendors include this functionality as part of their mobile switching center (MSC). For convenience of illustration, it is assumed that the BSC functionality in the network 3 is incorporated into the MSC 15.

In the example, through the MSC 15 and the base stations 17, a network 3 provides voice-grade telephone services over the common air interface to and from the mobile stations 5. The network 3 may include one or more additional elements (not separately shown), such as an inter-working function (IWF) or a Packet Data Serving Node (PDSN) to support data services over the logical communication channels of the wireless air interface, for example for the communications via the Internet.

A typical wireless network, such as a network 3, utilizes a number of logical channels for signaling related to the network services, for example for paging called stations, registration, and the like. For example, the serving network 3 sends alert messages to the mobile station 5 over the paging channel, when there is an incoming call to the station 5 or an incoming data message (e-mail or the like). The paging channel alert message contains address information specifically identifying the particular mobile station 5, and possibly information distinguishing the particular type of incoming call or message. In the uplink direction, the mobile station 5 registers with the network 3 serving the area in which the user is currently located. Once registered, the mobile station 5 periodically sends messages to the network 3 over the uplink access channel, to maintain its registered station.

The mobile telephone station 5 includes a transceiver compatible with the particular type of wireless network 1. The mobile stations 5, the MSCs 15 and the base stations 17 implement one or more standard air-link interfaces. For example, the wireless telephone network may support dual-mode services. Although not shown separately, such a dual-mode network includes wireless telephone components that output analog telephone signals for transmission according to an analog wireless protocol (e.g., AMPS) as well as digital wireless system components that operate in accord with a digital wireless protocol, for example the CDMA protocol IS-95. The base stations may provide both types of services. Alternatively, the network may comprise base stations that send and receive voice and signaling traffic according to the prescribed analog protocol as well as digital base stations that utilize the digital wireless protocol. Each dual-mode MSC typically includes a switching subsystem for analog telephone services, a switching subsystem for digital telephone services, and a control subsystem. Other MSCs may implement only one type of service.

Digital wireless equipment is available today to support any one of several common interface standards, including time division multiple access (TDMA) and the Global System for Mobile communications (GSM). In the preferred embodiment, the digital wireless telephone components support the code division multiple access (CDMA) standards.

With CDMA, each transmitted signal comprises a different pseudorandom binary sequence, also referred to as a pseudonoise (PN) sequence, which modulates a carrier signal, spreading the spectrum of the waveform. Thus, since each CDMA subscriber unit is assigned a unique PN code, a plurality of subscriber stations can send and receive CDMA signals sharing the same frequency spectrum. If these CDMA signals were viewed in either the frequency or time domain, the multiple access signals would appear to be superimposed on top of each other. The CDMA signals are separated in the receivers of the base stations or the subscriber stations by using a correlator or matched filter which accepts only signal energy from the selected binary PN sequence and despreads its spectrum. The CDMA signals from other sources, whose codes do not match the selected binary PN sequence, are not despread in bandwidth and as a result, contribute only to the background noise and represent a self-interference generated by the system.

As will be familiar to those of ordinary skill, an air-link interface for each cellular service in a geographic area includes paging channels and/or signaling channels, as well as actual communications channels for voice and/or data services. The channels may be separate frequency channels, or the channels may be logically separated, for example based on time division or code division. The paging and signaling channels are used for preliminary coded communications between a cellular telephone and a cell site in setting up a telephone call or other session, after which a communication channel is assigned or set up for the telephone's use on that call.

Each carrier operating apportion of the wireless network 1 also operates a home location register (HLR) that stores subscriber profiles for each of that carrier's wireless subscribers and their associated digital wireless stations 5. The HLR may reside in the home MSC, however, in the example, the HLR resides in a centralized service control point (SCP) 21. The SCP 21 communicates with the MSCs 21 via data links and one or more signaling transfer points (STPs) 23 of an out-of-band signaling system, typically, a signaling system 7 (SS7) network. As recognized in the art, the HLR stores for each mobile subscriber the subscriber's mobile telephone number, the mobile identification number, and information specifying the wireless services subscribed to by the mobile subscriber, such as numeric paging or text-based paging, data communication services, multiple alerting, etc. The subscriber profile record in the HLR may also provide data (e.g. transfer numbers) and control logic to implement enhanced service features, for example, to implement the multiple alerting service.

The carrier also operates a number of different systems in one or more customer service centers. These include one or more billing systems, client account administration systems, network provisioning systems 25 such as the Mobile Telephone Administration system or “MTAS”, and the like. The billing system (not shown), for example, receives usage and operations data from the MSCs 15 in the form or call detail records (CDRs) and processes that data to generate bills for individual customers and to forward data regarding users roaming through the carrier's service area through a clearinghouse (not shown) for reconciliation. The MTAS 23 provides data to the HLR in the SCP 21 and/or to the MSCs 15 to provision services for new stations 5 and modifies provisioning data as customers change their subscriptions to obtain different sets of services from the carrier. As such, these systems provide CDR data processing for billing for the multiple alerting service and provisioning of the network elements to set-up and/or modify the multiple alerting service.

Modern networks 1 typically include adjunct processors, to support various enhanced service features. An example of such a call processor is a voice mail system (VMS) 29. Calls that can not be completed are often routed to a VMS 29, for example, to callers to record voice messages for later retrieval by called parties. In the example, the system 3₁ includes a voice mail system 29₁; and the system 3₂ includes a voice mail system 29₂. As discussed more, later, the multiple alerting service offers an associated voice mail service. Typically, the system 1 will route a call for the pilot number, that is not completed to one of the destinations, to a voice mail box associated with the pilot number. A number of different conditions relating to un-completed calls, which may trigger routing to voice mail or other alternative routing operations, will be discussed with regard to the detailed call processing examples.

For discussion purposes, the drawing shows two regional networks 3, wherein the network 3₁, is an exemplary home network for the illustrated stations 5₁ to 5₃, and the network 3₂ is a visited network. As a customer using a mobile station 5 roams into the service area of another system 3₂, the station 5 registers with that system. If the visited system is still within the territory of the service provider serving that station, the location registration is simply updated. However, if the roaming station 5 registers with a system of a different service provider, service information is transferred from the HLR in the SCP 21 to a Visitor Location Register (VLR) 27 in the visited access network 3₂ during the successful registration process. Specifically, a visited wireless communication network 3₂ assigns a register, as a VLR, to a mobile station 5 during a period when the station roams into the wireless serving area of the visited provider's network and remains registered on that visited system. The VLR 27 communicates with the HLR in the SCP 21 to authenticate the mobile station 5 and obtain a copy of subscriber subscription service information, from the HLR during the registration process, typically via packet messages exchanged via the SS7 interoffice signaling network.

In a call placed to a telephone number of a wireless or mobile station 5 from a landline terminal 9 of PSTN network 7, the serving end office in the PSTN 7 recognizes the NPA-NXX digits in the dialed number as those of a carrier served through the tandem (not shown) that couples the PSTN to the called party's home MSC 15 in the network 3₁, in our example. The end office responds by routing the call to the tandem, and the tandem routes the call to the MSC 15 in network 31, for completion to the destination station 5. If the station 5 is registered with the particular system 3₁ (is within the home region), the MSC completes the call through the appropriate base station 17 and transmitter tower 19. If the station 5 is not registered with the home system 3₁ (is not within the home region), the originating MSC 15 in that region routes the call to the MSC (serving system) in the region 3₂ where the called station is currently registered as a visiting or roaming customer. The serving system may be a system of the same provider or a system operated by another provider. In the event that the called mobile station 5 does not answer, the MSC 15 designated as the home MSC rolls the call over to a voice mail system 15.

In modern networks, however, some services utilize AIN or other similar forms of ‘intelligent’ call processing to provide advanced features, such as multiple alerting. For those kinds of services, the MSC 15 processing a call to or from a mobile station 5 will detect an event in call processing commonly referred to as a “trigger.” Upon hitting a trigger, the MSC 15 will communicate through the links and STP(s) 23 of the SS7 signaling network with a database in an SCP 21 to obtain instructions regarding further processing of the call. The SCP typically is the one that provides the HLR, although some features could utilize a different one or an additional SCP. When the MSC that detected the trigger event has sufficient information, it will continue processing of the call. The latest implementations of such Advanced Intelligent Network (AIN) processing may involve multiple triggers and associated exchanges between the MSC and one or more SCPs to determine how to complete each individual call in accord with one or more AIN features provided to the user of the mobile station 5.

Modern mobile networks utilize such intelligent processing techniques to implement the roaming/registration functions, for example, by implementing the HLR and in some cases the VLR in AIN type SCP nodes. Such networks also use this type of processing to implement special features associated with the basic mobile telephone service. The subscriber profiles in the HLR/SCP 21 are used to implement the multiple alerting services, for example, to provide information to launch multiple call legs as well as to provide routing instructions for alternative terminations in the event that a multiple alerting call can not be completed for one of several reasons.

A subscriber to a multiple alerting service has an assigned pilot number. The pilot number is a mobile identification number (MIN) assigned to the subscriber's station 51. A call to the pilot number triggers access to the appropriate records in the HLR/SCP 21, using AIN type call processing. The records then allow the home system 31 to control the multiple alerting call legs as well as any alternative terminations.

The intelligent network control logic for the exemplary multiple alerting technique is not limited to successful (answered) calls to a multiple alerting group. It also sets forth criteria under which a call to a multiple alerting group should be treated as unsuccessful. The present multiple alerting operations give the home system 31 for a called group full control over the determination of whether unsuccessful call treatment should be provided for a call to a multiple access group, and they give the home system 3, full control over the nature of the unsuccessful call treatment that is provided in case the call is unsuccessful.

The present multiple alerting technique achieves the above cited control without any need for upgrades or for special protocol support on the part of any of the serving systems 32 to which members of the multiple alerting group may roam. This is important because those serving systems 32 may not belong to the same carrier that owns the home system 31 for the multiple alerting group. It also avoids the need for extensive inter-vendor interoperability testing.

In the example, the multiple alerting is limited to two tightly defined types of multiple alerting groups (standardized in industry standards, ANSI-664), the single user group and the multiple user group. Such an implementation only provides group voicemail or group redirection (as opposed to member voicemail or member redirection) for calls to a multiple alerting group.

In the implementation, the home system 3₁ recognizes a call as a multiple alerting call based on the presence of an ANSI standard GroupInformation parameter in the ANSI-41 LocationRequest RETURN RESULT, typically as sent from the HLR 21 back to the originating MSC 15₁. Also, the home system 3₁ distinguishes between single user groups and multiple user groups based on the setting of the ANSI standard TerminationTriggers parameter accompanying the ANSI standard GroupInformation parameter in the ANSI-41 LocationRequest RETURN RESULT. In contrast, the ANSI standardized implementation of this feature relies on the ability of serving systems to receive and store a LegInformation parameter for a call delivery leg to a group member, and then to return that LegInformation parameter in any request for leg redirection sent by the serving system to the home system 3₁. This imposes a requirement for serving system upgrades that is not imposed by the exemplary method of supporting multiple alerting groups.

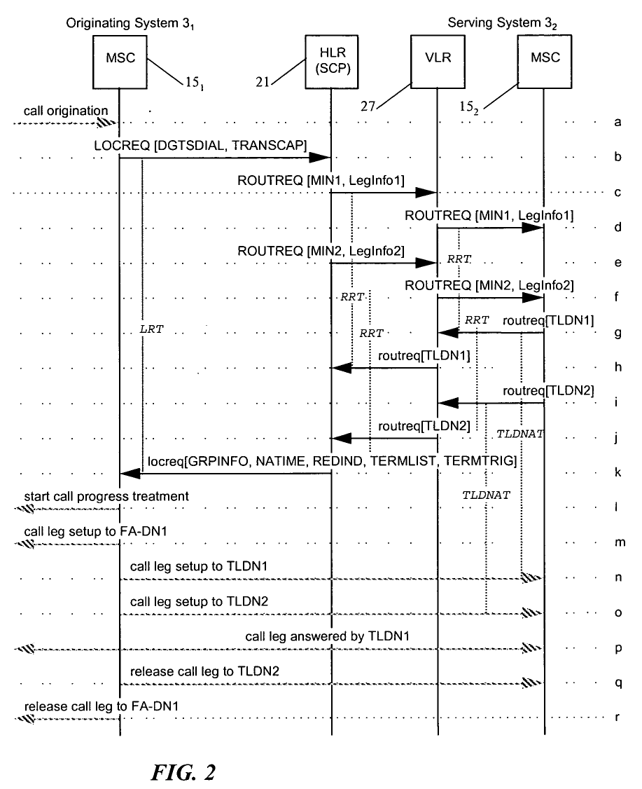

To insure understanding of the operation of the multiple alerting service, it may be helpful to consider several examples. First, FIG. 2 shows the signal flow that occurs in the wireless networks 3 during processing of a call to a primary number of a multiple alerting subscriber and routing of two multiple alerting legs to mobile stations and one leg to a landline destination number. For purposes of discussion, assume that the call is initiated by a calling party using one of the stations 9, although of course the incoming call may originate at another mobile station 5.

In the example of FIG. 2, the PSTN 7 routes the call to the home MSC 15₁ of the station 5, that has the pilot or primary multiple alert telephone number as its assigned mobile identification number (MIN). From the perspective of the mobile network 3₁, the home MSC 15₁ detects origination (line a) of an incoming call to the pilot MIN number. The signaling for the origination of the call from the PSTN 7 identifies the pilot number, which initially triggers AIN call processing. In response to the trigger, the home MSC 15₁ launches a location request message LOCREQ through the signaling network to the SCP, to access the record in the HLR 21 for that number (line b). The location request message LOCREQ includes the dialed digits (DGTSDIAL) and one or more transaction capability parameters.

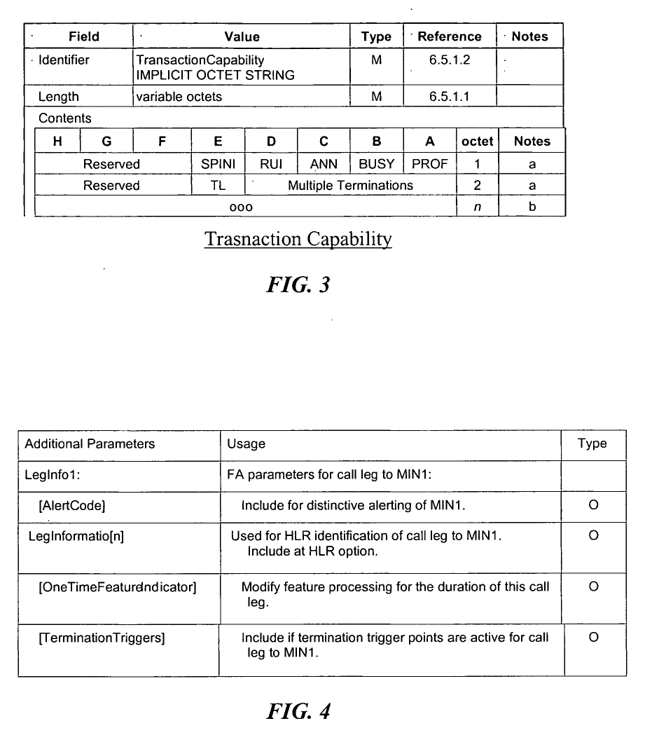

The table in FIG. 3 illustrates examples of the transaction capability parameters. The HLR 21 uses the data in the location request message LOCREQ to access an appropriate record in its database and obtain additional information needed for the legs of the multiple alerting call that relate to mobile stations that are members of the multiple alerting group. In this simple example, assume that there is one additional mobile member number in the multiple alert group and one landline member number.

The record in the HLR, associated with the pilot multiple alert telephone number includes the logic for determining how to process the incoming call. For example, the record indicates that the called number relates to a subscriber to a multiple alerting service and identifies all of the member destination numbers associated with the pilot number. In the example, the pilot number MIN1 relates to a mobile station 5₁, and one other number MIN2 relates to a second mobile member station 5₂ of the alerting group. The landline member number is indicated by the FA-DN1 number in the illustrated example.

For each of the member numbers that are MINs of mobile stations 5, the HLR record for that number identifies the current location of registration, e.g. in the home system or at a VLR 27 in which the particular station is registered for roaming. For purposes of the example, the HLR record indicates that the station 5₁ associated with the pilot number has roamed into and registered with the visited regional network 3₁. The SCP/HLR 21 therefore transmits a route request message ROUTREQ through the signaling network to the VLR 27 (line c) and thence to the MSC 15₂ (line d) with which the station 5, is currently registered. This message transmission initiates a first of the multiple legs that the home system generates in providing the multiple alerts to various potential answering points.

The HLR data also indicates the current registration location of the second mobile station member 5₂. For simplicity, it is assumed that the second mobile member station 5₂ is registered with the same VLR 27, although of course the second mobile member station will often be roaming in other regions or in the home network and thus registered at other locations. Hence, at this point in the exemplary call processing (FIG. 2), the HLR initiates signaling to obtain the data necessary for the additional leg to the other mobile member number MIN2 of the multiple alerting group associated with the pilot number. In the simple example, the HLR 21 initiates second signaling, by transmitting a route request message ROUTREQ through the signaling network to the VLR 27 (line e) and thence to the MSC 15₂ (line f) with which the station 5₂ of the second member MIN number is currently registered.

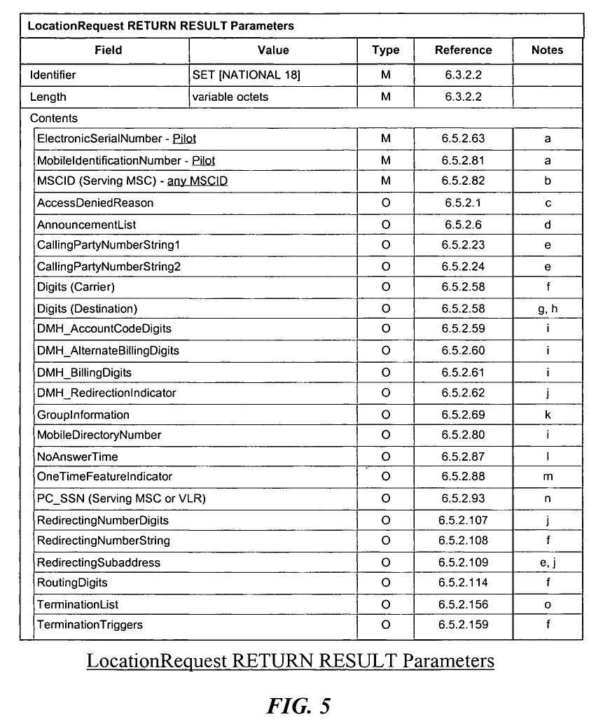

In response to each ROUTREQ for a respective MIN, the MSC 15₂ assigns a temporary location directory number (TLDN) to the particular station 5₁ or 5₂ and provides that number to the VLR 27 which transmits the assigned TLDN number back to the HLR 21 (see lines g through j). Upon receiving the TLDNs, the HLR 21 transmits a message back through the signaling network to the MSC, specifically a location request response message (locreq at line k). The table in FIG. 4 shows additional parameters that may be included in the HLR record for controlling the multiple alerting service, and an example of the data that may be included in the location request response message is shown in the table in FIG. 5. Of note, the message sent to the MSC 15₁ includes the assigned TLDNs and any landline destination numbers (such as the Flexible Alerting number FA-DA1), for the members of the multiple alerting group.

The MSC 15₁ starts sending the call progress treatment signals (e.g. ringback tones) to the calling party's station 9 (line 1). At this point in the call processing, the originating side MSC 15₁ in the home network 3₁ of the pilot number station 5₁ initiates the actual separate call legs through the network 1. For example, if there are any landline destination numbers in the group (e.g. FA-DN1), the MSC 15₁ starts a call leg setup through the PSTN to each such number (see line m).

At this point, the MSC 15₁ has received the assigned TLDNs from the HLR 21, for the pilot and mobile member numbers. Hence, the originating MSC 15₁ uses the TLDNs to initiate calls through the network to the terminating MSC 15₂ (see lines n and o). In response to the signaling messages regarding the two TLDNs, the serving MSC 15₂ transmits signaling over the air link to the two stations 5₁ and 5₂ regarding the respective incoming calls and awaits answer responses. This signaling may support distinctive alerting, for digital type mobile stations 5₁ or 5₂, for example, to provide a distinctive visible or audible indication that the incoming call is a multiple alerting service call.

Upon receiving an answer, in this example, from the station 5₁, the MSC 15₂ transmits a signaling message signifying an answer to the leg based on the TLDN1 number back through the signaling network to the originating MSC 15₁, and messages are exchanged between the MSCs to set-up the voice link between the calling station 9 and the first answering station 5₁ (see line p). Voice communication or the like ensues between the calling party at the station 9 and the answering party at the station 5₁.

Upon setup of the voice link, the originating MSC 15, releases the other multiple alerting call legs, in this example, by sending a release message regarding the TLDN2 number assigned to the mobile station 5₂ to the MSC 15₂ (line q) and a release message through the PSTN regarding the land line member number FA-DN1 (line r).

In the example, the service was controlled entirely by the home system 31, specifically, by the HLR record associated with the pilot number stored in the SCP 21 and by originating/home MSC 15₁. The VLR 27 and visited MSC 15₂ respond to each leg relating to one of the MINs in the same way as they would for any other call to a roaming mobile station. Hence, no adaptation or programming of the VLR 27 or MSC 15₂ is needed to support the multiple alerting service.

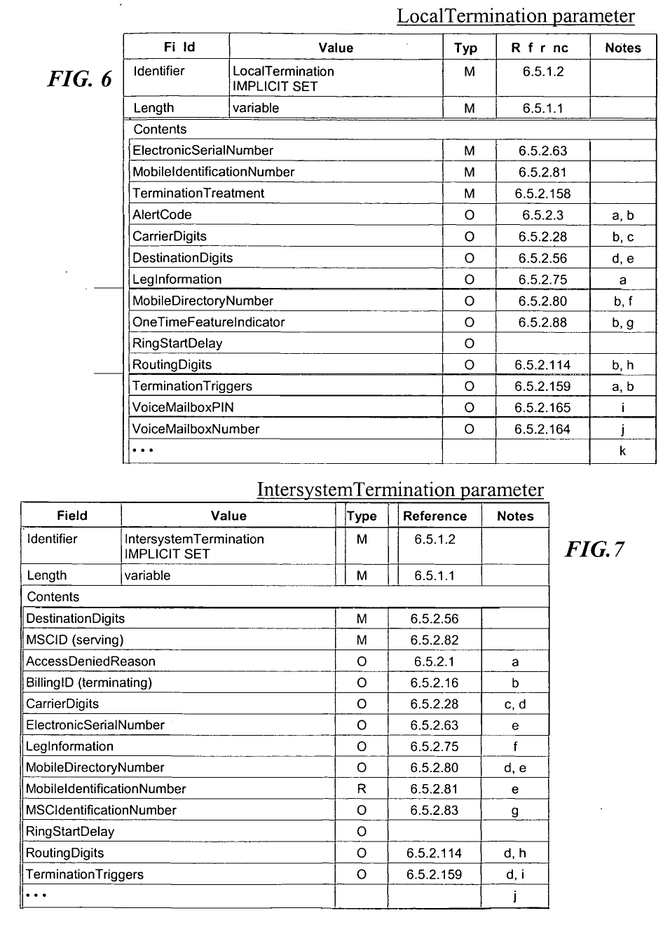

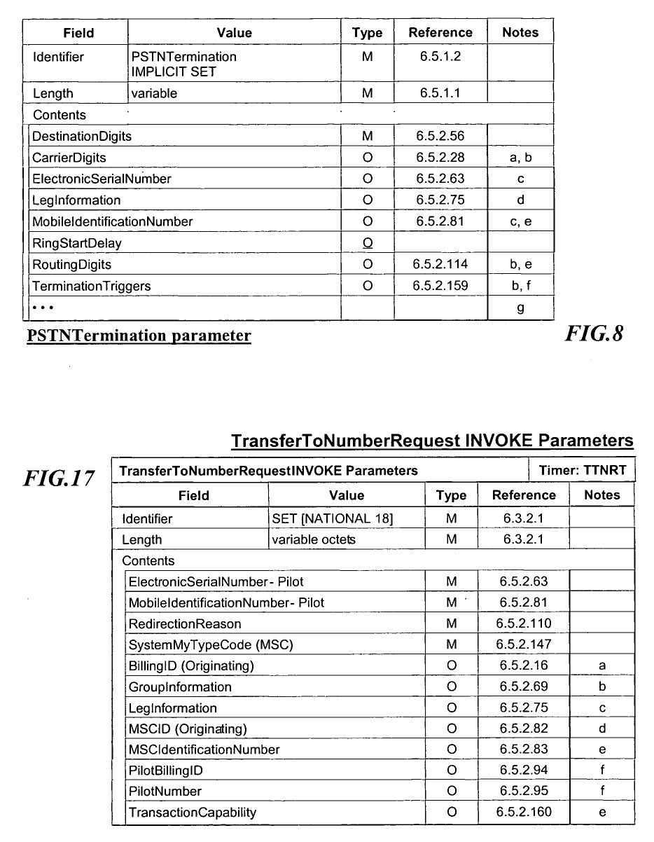

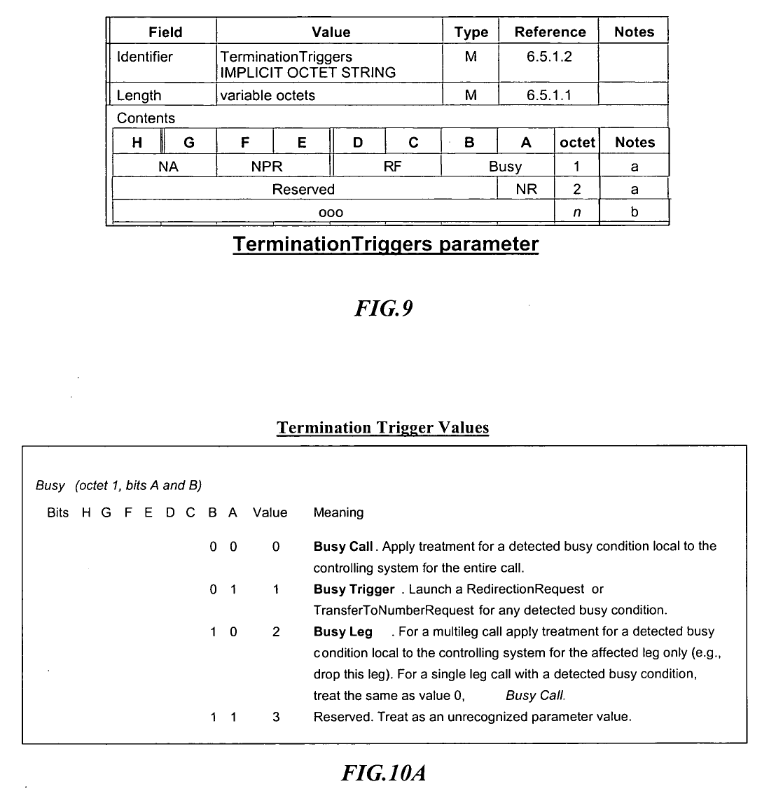

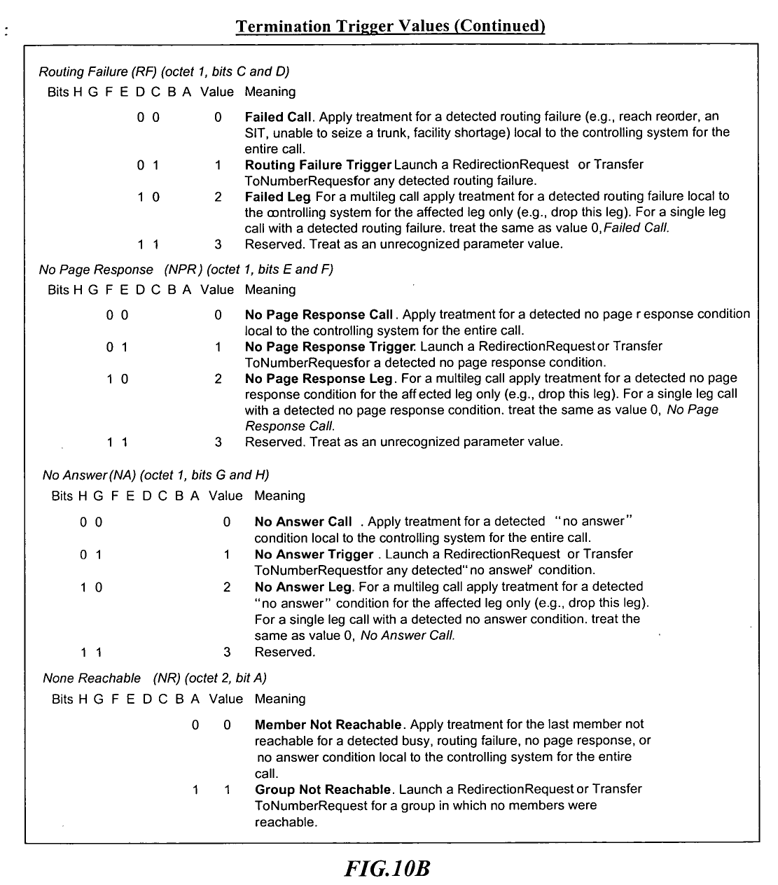

As discussed here, the home system 3₁ also controls termination of multiple alerting calls, including alternative termination treatments in the event that a call is not successfully routed to a destination station in the multiple alerting group. The network may apply such treatments to any type of call-failure, e.g. to failure due to ‘no-answer’, failure due to various station-busy or station-unreachable conditions, failure due to network-busy conditions, etc. A variety of termination parameters that may be used are shown in the tables in FIGS. 6 to 9, and the table in FIGS. 10A and 10B shows the values and meaning of the termination trigger values.

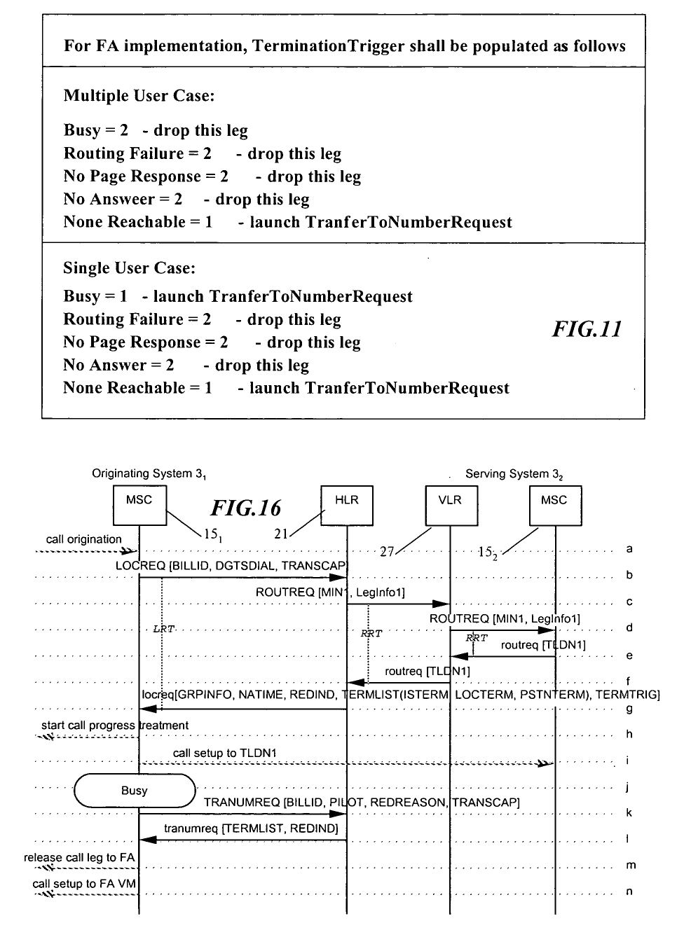

In a commercial implementation referred to as Foreign Alerting (FA) the termination trigger in the home MSC 15₁ is set as shown in FIG. 11. For a multiple user subscription, if the second leg (or additional legs) result in a busy, a routing failure, a no page response (for mobile station) or a no answer, then the trigger implementation causes the originating MSC 15₁ to drop that leg. However, if none of the members are reachable, the trigger initiates a transfer to a different number, typically to a number for a voice mailbox maintained in a voice mail system (VMS) 29₁ associated with the originating MSC 15₁.

By contrast, for a single user subscription, if the first leg to the pilot number results in a busy, the trigger initiates a transfer to a different number, typically to a number for a voice mailbox maintained in a voice mail system (VMS) 29₁ associated with the originating MSC 15₁. If there is a routing failure, a no page response (for mobile station) or a no answer for the second (or any further) legs, then the trigger implementation causes the originating MSC 15₁ to drop that leg. Again, if none of the members are reachable, the trigger initiates a transfer to a different number, typically to the number for a voice mailbox maintained in a voice mail system (VMS) 29₁ associated with the originating MSC 15₁.

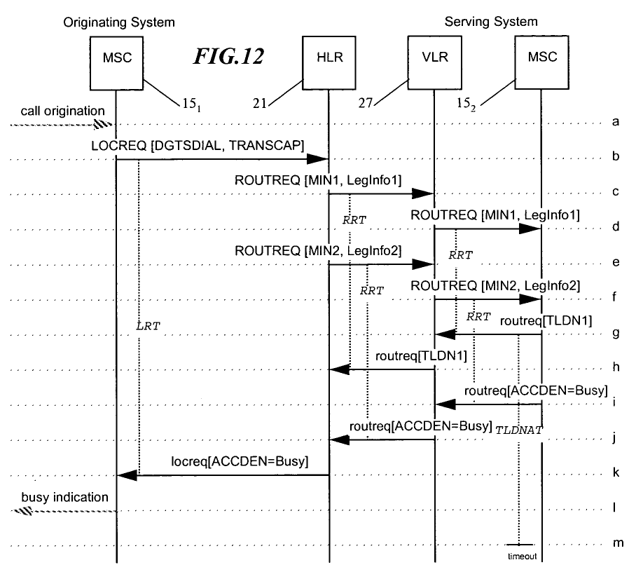

To appreciate the various ways that the service may be setup for different subscribers, it may be helpful to consider a few specific call processing examples. FIG. 12 shows the signal flow that occurs in the wireless network 1 during processing of a call to a pilot number, similar to the example of FIG. 2, but in which the second member mobile station is busy at the time of the incoming multiple alerting call. For purposes of discussion, assume that the call is initiated by a calling party using one of the stations 9, though of course the incoming call may originate at another mobile station 5.

In the example of FIG. 12, the PSTN 7 routes the call to the home MSC 15₁ of the station 5₁ that has the pilot multiple alert telephone number as its assigned mobile identification number (MIN). From the perspective of the mobile network 3₁, the home MSC 15₁ detects origination (line a) of an incoming call to the pilot MIN number. The signaling for the origination of the call from the PSTN 7 identifies the pilot number, and in response, the home MSC 15₁ launches a location request message LOCREQ through the signaling network to the SCP, to access the record in the HLR 21 for that number (line b). The location request message LOCREQ includes the dialed digits (DGTSDIAL) and one or more transaction capability parameters.

As discussed above, the record in the HLR, associated with the pilot multiple alert telephone number, includes the logic for determining how to process the incoming call as well as the current location of registration, e.g. in the home system or at a VLR 27 in which the particular station is registered for roaming. For purposes of the example, the HLR record indicates that the station 5₁ associated with the pilot number (MIN1) has roamed into and registered with the visited regional network 31. The SCP/HLR 21 therefore transmits a route request message ROUTREQ through the signaling network to the VLR 27 (line c) and thence to the MSC 15₂ (line d) with which the station 5₁ is currently registered.

In the simple example, the HLR data also identifies the MIN and indicates the current registration location of the second mobile station member 5₂. For simplicity, it is assumed that the second mobile member station 5₂ is registered with the same VLR 27, although of course the second mobile member station will often be roaming in other regions or in the home network and thus registered at other locations. Hence, at this point in the exemplary call processing (FIG. 12), the HLR initiates signaling to obtain the data necessary for the additional leg to the other mobile member number MIN2 of the multiple alerting group associated with the pilot number. In the simple example, the HLR initiates the second signaling, by transmitting a route request message ROUTREQ through the signaling network to the VLR 27 (line e) and thence to the MSC 15₂ (line f) with which the station 5₂ of the second member MIN number is currently registered.

In response to each ROUTREQ for a respective MIN, the MSC 15₂ assigns a temporary location directory number (TLDN). Hence, in this example, the MSC 15₂ assigns TLDN1 to the first station 5₁ and provides that number to the VLR 27 which transmits the assigned TLDN number back to the HLR 21 (see lines g and h). To this point, the process in FIG. 12 is identical to that in FIG. 2. However, now assume that the station 5₂ of the second member is busy. The return result messages (lines i and j) for the route request relating to the second mobile number (MIN2) therefore indicates a station busy condition.

The HLR 21 transmits a message back through the signaling network to the MSC, specifically a location request response message (locreq at line k). However, due to the indicated busy condition, rather than providing the TDLN numbers in this message as in the example of FIG. 2, the HLR 21 populates this return result message with a “busy” status indicator. For this example, it is assumed that the subscriber service logic dictates a busy signal result to the caller, in the event that any one station in the group is busy at the time of the multiple alerting call.

At this point, the originating MSC 15₁ processes the call in accord with the termination treatment specified by the subscriber's record, typically, as selected by the subscriber associated with the pilot number. For simplicity of discussion here, assume that there is no alternate routing selected (no voice mail or the like), therefore the originating MSC 15₁ sends the “busy” indication call progress treatment signal to the calling party's station 9 (line 1). Processing by the originating MSC ends. The serving MSC 15₂ however has assigned a TLDN1 to the first leg of the call and is awaiting a call leg to that number. Since no such call arrives from the originating MSC 15₁, the serving MSC 15₂ waits for a set time interval, and when the interval times out (line m), that MSC returns the assigned TLDN number to its pool for reassignment.

The logic for processing the call upon occurrence of busy conditions may provide a similar treatment or a different treatment in the event that all destination numbers (pilot and members) are busy. As discussed more below, the subscriber profile in the HLR/SCP can set a variety of different termination treatments to be applied.

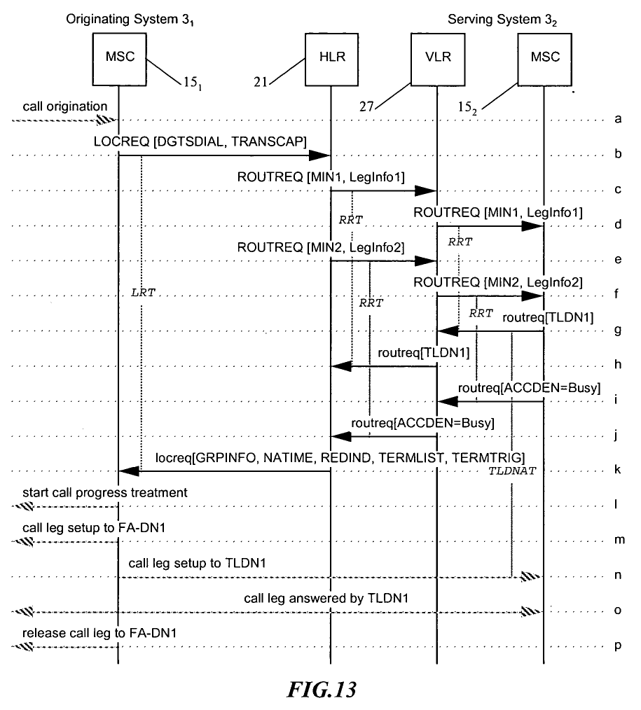

FIG. 13 is another example in which the second mobile station is busy. Processing in the initial steps (lines 1 through i) is identical to that discussed above relative to FIG. 12. In this example, however, the termination treatment set up in the HLR record and the originating system MSC 15₁ does not terminate the call if just one mobile station is busy. Instead, in this example, the service parameters in the subscriber profile in the HLR are set to continue multiple alerting treatment with respect to the other numbers.

At this point in the call processing, the HLR 21 has obtained a TLDN1 for the station associated with the pilot MIN1 number and has received an indication that the station associated with the second mobile member MIN2 number is busy. The HLR 21 transmits a message back through the signaling network to the MSC 15₁, specifically a location request response message (locreq at line k). In this example, however, the message sent to the MSC 15₁ includes the assigned TLDN1 and any landline destination numbers (such as the Flexible Alerting number FA-DA1), for the stations of the multiple alerting group.

The MSC 15₁ starts sending the call progress treatment signals (e.g. ringback tones) to the calling party's station 9 (line 1). At this point in the call processing, the originating side MSC 15₁ in the home network of the pilot number station 5₁ initiates the actual separate call legs through the network 1. For example, if there are any landline destination numbers in the group (e.g. FA-DN1), the MSC 15₁ starts a call leg setup through the PSTN to each such number (see line m). The MSC 15₁ also uses the TLDN1 to initiate a call through the network to the terminating MSC 15₂ (see lines n), with respect to the non-busy station, in this case station 5₁. In response to the signaling message regarding TLDN1, the serving MSC 15₂ transmits signaling over the air link to the station 5₁ regarding the incoming call and awaits an answer response. Upon receiving an answer from the station 5₁, the MSC 15₂ transmits a signaling message signifying an answer to the leg based on the TLDN1 number back through the signaling network to the originating MSC 15₁, and messages are exchanged between the MSCs to set-up the voice link between the calling station 9 and the first answering station 5₁ (see line o in FIG. 13). Upon setup of the voice link, the originating MSC 15₁ releases the other multiple alerting call legs, in this example, the leg for the land line member number FA-DN1 (line p).

In the preceding example, the group included three numbers, the pilot mobile number and two member numbers (one mobile and one landline). The FA implementation of the multiple alerting service, however, supports up to five member destination numbers (DNs). Up to three member DNs will be alerted at the same time.

Assume now that a subscriber's multiple alerting group includes the pilot number and four or five member DNs. The processing, such as discussed above relative to FIGS. 2 and 13 will initially alert the station 51 associated with the pilot number and the stations 5₂, 5₃ or 9 associated with the member DNs. In the event that one of the stations initially selected for multiple alerting is busy, for example at line i in the process of FIG. 13, the HLR 21 selects the next available DN and provides that alternate member DN in the terminal list in the return result location request (locreq) message in line k. In this way, when the originating MSC 15₁ receives the list of TLDNs and landline DNs for the multiple legs, the number for the busy station has been replaced with the next available DN in the subscriber's group.

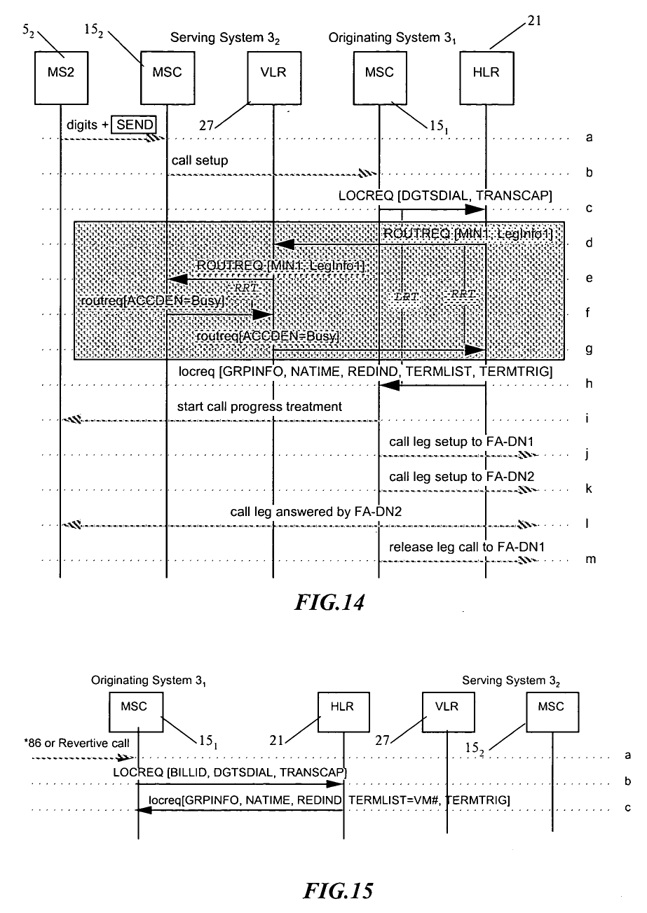

FIG. 14 illustrates the call processing flow, where the call to the pilot number originates from a mobile station (MS2) 5₂ that is a member of the multiple alerting group. In the process illustrated in this drawing, the mobile station sends the dialed digits (line a) to the MSC 15₂ currently serving that station. The MSC 15₂ recognizes the dialed number as one that is homed-on the MSC 15₁ and sends an initial call setup message (line b) to the originating MSC 15₁.

The signaling for the origination of the call (line b) identifies the pilot number, and in response, the home MSC 15₁ again launches a location request message LOCREQ through the signaling network to the SCP, to access the record in the HLR 21 for that number (line c). The location request message LOCREQ includes the dialed digits (DGTSDIAL) and one or more transaction capability parameters.

As in the earlier examples, the record in the HLR, associated with the pilot multiple alert telephone number includes the logic for determining how to process the incoming call. For example, the record indicates that the called number relates to the subscriber to the multiple alerting service and identifies all of the member destination numbers associated with the pilot number. Normally, the HLR 21 would obtain or provide data for legs to the pilot number and legs for up to three member DN numbers, for simultaneous alerting. In this example, the first member number MIN2 relates to the mobile station 5₂ that initiated the call, and the alerting group includes to other member numbers FA-DN1 and FA-DN2.

For any of the member numbers that are MINs of mobile stations 5, in this case the MIN1 of station 5₁, the HLR record also identifies the current location of registration, e.g. in the home system or at VLR 27 in which the particular station is registered for roaming. For purposes of the example, the HLR record indicates that the station 5₁ associated with the pilot number has roamed into and registered with the visited regional network 3₁. The SCP/HLR 21 therefore transmits a route request message ROUTREQ through the signaling network to the VLR 27 (line d) and thence to the MSC 15₂ (line e) with which the station 5₁ is currently registered. In this example, however, the station 5₁ is busy. Hence, a busy station indication is sent back in the respective response messages (lines f and g). It is not necessary to launch a location request regarding the station assigned MIN2, as that station originated the call.

At this point, the HLR 21 has obtained any necessary TLDN numbers (if any members other than the caller have mobile stations as in the earlier examples) and/or the HLR record has provided any DN numbers for other member stations. If there are more than three members, the HLR 21 selects one or more available DNs, to replace the leg that otherwise would have been associated with the MIN2 member and/or to replace the busy leg, in this example, to station 5₁. The HLR 21 now transmits a message back through the signaling network to the originating (home) MSC 15₁, specifically a location request response message (locreq at line h). The message sent to the MSC 15₁ includes the assigned TLDNs and any landline destination numbers (such as the Flexible Alerting number FA-DA1), for the members of the multiple alerting group. In this example, the message does not include any TLDNs because the mobile station member 5₁ was busy and the caller is using the member station 5₂, but the message includes the other two member numbers FA-DN1 and FA-DN2.

The MSC 15₁ starts sending the call progress treatment signals (e.g. ringback tones) to the calling party's station 5₁ (line i). At this point in the call processing, the originating side MSC 15₁ in the home network of the pilot number station 5 initiates the actual separate call legs through the network 1. In this example, the MSC 15₁ initiates a first call leg (line j) through the PSTN 7 to the first landline destination number FA-DN1; and the MSC 15₁ initiates a second call leg (line k) through the PSTN 7 to the second landline destination number FA-DN2.

Upon receiving an answer, in this example, from the PSTN indicating an answer by the station associated with the second call leg, messages are exchanged between the MSCs and the PSTN 7 to set-up the voice link between the calling station 5₁ and the first answering station; and voice grade communication ensues (line 1). Upon setup of the voice link, the originating MSC 15₁ releases the other multiple alerting call legs, in this example, by sending a release message regarding the regarding the land line member number FA-DN1 (line m).

In the example of FIG. 14, the service again was controlled entirely by the home system 3₁, specifically, by the HLR record associated with the pilot number stored in the SCP 21 and by the originating/home MSC 15₁. Although not shown here for simplicity, the trigger and profile record in the home system 31 would again control alternate terminations, for example, conditions under which calls not completed to a member of the multiple alerting group might be routed to a particular voice mailbox. Of note, however, because the call originated from a member, the busy condition of that member by itself was not enough to result in a call route to voice mail.

There are a number of ways that the subscriber to the multiple alerting service can retrieve voice mail messages from the associated mailbox. For example, the subscriber may dial a code such as *86 or dial the station's own number (revertive). As shown in FIG. 15, when the originating MSC 15₁ receives the initial signaling for such a call (line a), that MSC launches a route request message with the billing ID of the calling station, the dialed digits and one or more transaction capability parameters to the HLR 21 (line b). The HLR 21 sends back a corresponding locreq type return result message (line c) containing the data necessary to route the call to the appropriate mailbox in the voice mail system (VMS) 29₁.

FIG. 16 is a signal flow diagram of another example of a multiple alerting call process. In this example, for a single user service implementation, the call results in a ‘busy’ determination with regard to one member station. For purposes of this discussion, assume that the call is initiated by a calling party using one of the stations 9, although the incoming call may originate at another mobile station 5. The PSTN 7 routes the call from the station 9 to the home MSC 15₁ of the station 5₁ that has the pilot or primary multiple alert telephone number as its assigned mobile identification number (MIN). From the perspective of the mobile network, the home MSC 15₁ detects origination (line a) of an incoming call to the pilot MIN number. The signaling for the origination of the call from the PSTN 7 identifies the pilot number, and in response, the home MSC 15₁ launches a location request message LOCREQ through the signaling network to the SCP, to access the record in the HLR 21 for that number (line b). The location request message LOCREQ includes the billing identification, the dialed digits (DGTSDIAL) and one or more transaction capability parameters.

The HLR 21 uses the data from the location request message LOCREQ and the profile associated with the pilot number (and each mobile member number if any), to launch a ROUTREQ query to the VLR 27 (line c) and thence to the appropriate MSC 15₂, in the system 32 where the respective station is currently registered. In this single user example, assume that there is no additional mobile member number in the multiple alert group. Hence, only the qury for the pilot number (MIN1) of the station 5₁ is shown.

In response to the ROUTREQ for the pilot number (MIN1), the MSC 15₂ assigns a temporary location directory number (TLDN) to the station 5₁ and provides that number to the VLR 27 which transmits the assigned TLDN number back to the HLR 21 (see lines e and f). Upon receiving the TLDN, the HLR 21 transmits a message back through the signaling network to the originating MSC 15₁, specifically a location request type return result message (locreq at line g), including the assigned TLDN for the station associated with the pilot number.

The MSC 15₁ starts sending the call progress treatment signals (e.g. ringback tones) to the calling party's station 9 (line h). The MSC 15₁ uses the TLDN to initiate a call leg through the network to the terminating MSC 15₂ (line i). In response to the signaling message regarding the assigned TLDN, the serving MSC 15₂ transmits signaling over the air link to the stations 5₁ regarding the incoming call and awaits an answer response. If there are member numbers, the originating MSC may launch other legs, as in the earlier examples.

In this example, however, the station 5₁ associated with the pilot number is busy or otherwise does not answer (line j). Upon receiving a busy signal or otherwise recognizing a no answer condition, the originating MSC 15₁ sends another message to the HLR 21 (line k). The message here is a transfer to number request (TRANUMREQ) message. FIG. 17 is a table showing the parameters that may be provided in a transfer-to-number request message. Of note, this message includes the billing identification, the pilot number, the reason for the redirection (busy in this example), and one or more transaction capability parameters. Based on the data in the transfer to number request message, the SCP accesses the HLR record of the pilot number and determines how the unanswered call should be terminated, for example, by looking up a voice mail box number.

Based on the HLR record, a return result message regarding the transfer to number (tranumreq) is sent back to the originating MSC 15₁, identifying the alternate routing number to which the call should be redirected (line 1). The originating MSC 15₁, provides release signaling for any other multiple alerting call legs (line m) and initiates signaling to setup the call to the voice mail (VM) service, typically using a number assigned to the voice mail system 29₁ in the home system 3₁.

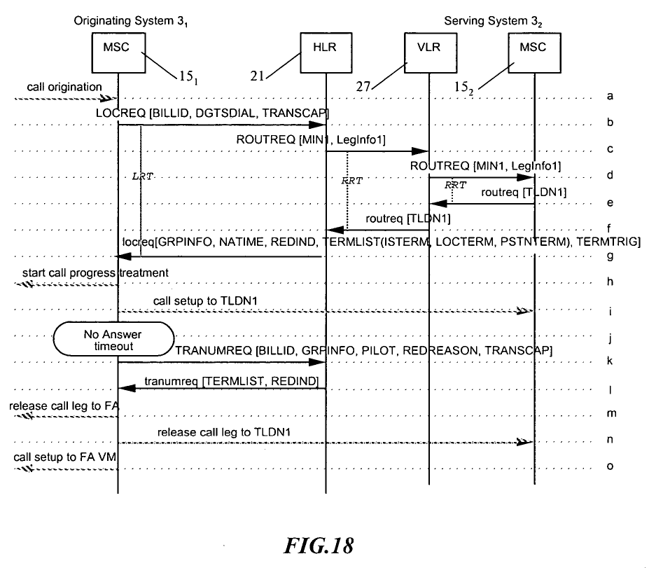

FIG. 18 is a signal flow diagram of another example of a multiple alerting call process, wherein the call results in a ‘no answer’ determination (due to time out) with regard to one member station in a multiple user service implementation. Again, for purposes of this discussion, assume that the call is initiated by a calling party using one of the stations 9, although the incoming call may originate at another mobile station 5. The PSTN 7 routes the call from the station 9 to the home MSC 15₁ of the station 5₁ that has the pilot or primary multiple alert telephone number as its assigned mobile identification number (MIN). From the perspective of the mobile network, the home MSC 15₁ detects origination (line a) of an incoming call to the pilot MIN number. The signaling for the origination of the call from the PSTN 7 identifies the pilot number, and in response, the home MSC 15₁ launches a location request message LOCREQ through the signaling network to the SCP, to access the record in the HLR 21 for that number (line b). The location request message LOCREQ includes the billing identification, the dialed digits (DGTSDIAL) and one or more transaction capability parameters.

The HLR 21 uses the data from the location request message LOCREQ and the profile associated with the pilot number, to launch a ROUTREQ query to the VLR 27 (line c) and thence to the appropriate MSC 15₂, in the system 3₂ where the first station 5₁ is currently registered. In a multiple user example, there will be multiple ROUTREQ queries, with one ROUTREQ query relating to each MIN in the group, although only one such MIN is shown here for simplicity.

In response to the ROUTREQ for each mobile number, the MSC 15₂ assigns a temporary location directory number (TLDN), in this simple illustration to the station 5₁, and the MSC 15₂ provides that number to the VLR 27 which transmits the assigned TLDN1 number back to the HLR 21 (see lines e and f). Upon receiving the TLDN, the HLR 21 transmits a message back through the signaling network to the originating MSC 15₁, specifically a location request return result message (locreq at line g), including the assigned TLDN for the station associated with the pilot number. The terminal list in this message may include a TLDN for a DN for any other available members.

The MSC 15₁ starts sending the call progress treatment signals (e.g. ringback tones) to the calling party's station 9 (line h). The MSC 15₁ starts call setup for the legs to the various member numbers or to the assigned TDLNs for mobile members, received in the preceding response (locreq). For example, that MSC uses the TLDN to initiate a call leg through the network to the terminating MSC 15₂ (line i). In response to the signaling message regarding the assigned TLDN1 number, the serving MSC 15₂ transmits signaling over the air link to the station 5₁ regarding the incoming call and awaits an answer response.

In this call example, however, the originating MSC does not receive a signaling message relating to a response before expiration of a timer associated with the multiple alerting service. Although only one call leg is shown for convenience, in this case, the timer expires in the event that there is no answer to any of the call legs. Hence, in a multiple leg scenario, the condition is met if there is no answer at any of the multiple alerting destinations. At line j in this example, the no answer timer function times out.

In response to the time out condition, the originating MSC 15₁ sends another message to the HLR 21 (line k). The message here is a transfer to number request (TRANUMREQ) message. As noted above, FIG. 17 is a table showing the parameters that may be provided in a transfer-to-number request message. Of note, in the example of FIG. 18, this message includes the billing identification, group information, the pilot number, the reason for the redirection (no answer in this example), and one or more transaction capability parameters. Based on the data in the transfer to number request message, the SCP accesses the HLR record of the pilot number and determines how the unanswered call should be terminated, for example, by looking up a voice mail box number.

Based on the HLR record, a return result message regarding the transfer to number (tranumreq) is sent back to the originating MSC 15₁, identifying the alternate routing number to which the call should be redirected under the present conditions (line 1). This number may be the same as or different from the transfer number used to redirect a call in response to a busy condition. For purposes of this simple example, however, assume that the number for redirection is the same as in the example of FIG. 16. The originating MSC 15₁, provides release signaling for any other multiple alerting call legs (line m) and initiates signaling to setup the call to the voice mail (VM) service, typically using a number assigned to the voice mail system 29₁ in the home system 3₁.

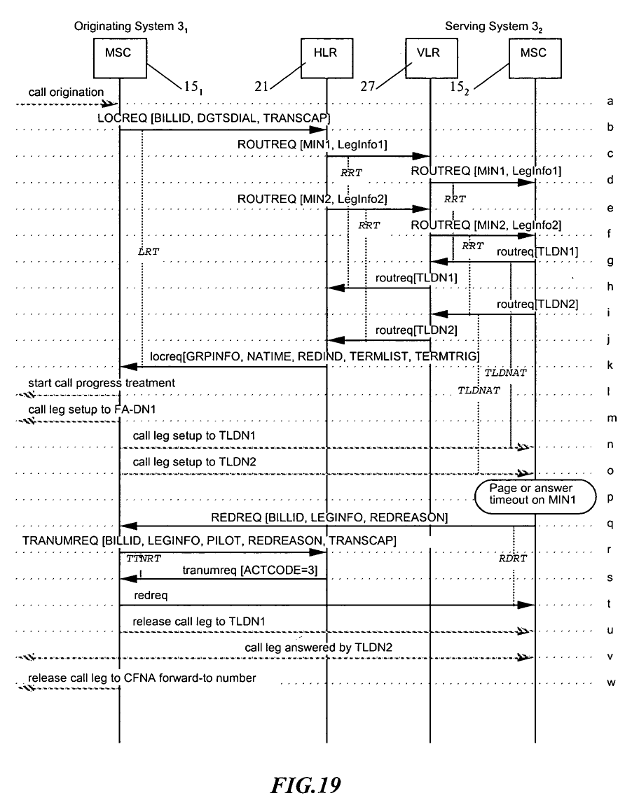

FIG. 19 is a signal flow diagram of another example of a multiple alerting call process, wherein the call results in a ‘no answer’ determination, but with an associated member redirection. Processing in this example is essentially the same as in the example of steps shown in lines a to o of FIG. 2. However, in this example, the MSC 15₂ serving the station 5₁ detects a no answer condition (line p), for example when the page/answer timer for signaling to that station times out without a signaling response from the station 5₁. This may occur because the station is temporarily unreachable, although its registration with the serving system 3₂ is still valid.

In this situation, the serving MSC 15₂ responds to the first multiple alerting leg with a redirection request (REDREQ) message, containing the billing identification, leg information and data as to the reason to redirect the call. In response, the originating MSC 15₁ sends another message to the HLR 21 (line r). The message here is a transfer to number request (TRANUMREQ) message containing the billing identification, leg information, the pilot number, the reason for the redirection, and one or more transaction capability parameters. Based on the data in the transfer to number request message, the SCP accesses the HLR record of the pilot number and determines how the unanswered call should be terminated, for example, by looking up a voice mail box number.

In this example, the no answer by the station associated with the pilot number is not a condition sufficient by itself to generate an alternate termination, as the network is still waiting to see if there is an answer on another call leg. The response message tranumreq (line s) therefore includes an action code, to allow continued processing of the call. The originating MSC 15₁ provides a response message (redeq) to the serving MSC 15₂ (line t), and the originating MSC 5₁ sends a release message through to the MSC 15₂ regarding the first leg, that is to say corresponding to the assigned member TLDN1 number (line u).

However, processing regarding other multiple alerting legs continues. As noted earlier, the HLR may provide or obtain data for launching an additional leg to the next available DN, if there are more than three member DNs for the subscriber's group. In this simple example, the second leg based on the TLDN2 number assigned to the second mobile station group member continues. Assume for discussion purposes, that the user of that station answers the second leg of the call. Upon receiving an answer, the MSC 15₂ transmits a signaling message signifying an answer to the leg based on the TLDN2 number back through the signaling network to the originating MSC 15₁, and messages are exchanged between the MSCs to set-up the voice link between the calling station 9 and the mobile station 5₂ (see line v). Upon setup of the voice link, the originating MSC 15₁ releases any other multiple alerting call legs, for example, by sending a release message regarding a forward-to number (line w).

A mobile network such as shown in FIG. 1 will also support a variety of other services, some of which will interact with the multiple alerting service. For example, some calls to the pilot number may not originate in response to a traditional dialing operation. For example, a destination station called by the station 5₁ associated with the pilot number (MIN1) may imitate a return call to the pilot number by dialing *69. The system 1, however, will provide the multiple alerting service in essentially the same manner as discussed above.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method of providing multiple alerting service through a mobile communication network, comprising:
receiving a call for a pilot number of a multiple alerting group, at a mobile switching center (MSC) serving as a home MSC for the pilot number;
accessing a home location register record associated with the pilot number, to obtain roaming location information of a mobile station assigned the pilot number and information regarding routing to at least one additional member number;
launching a first call leg from the home MSC through the mobile communication network, for the pilot number, based on the obtained roaming location information,;
launching a second call leg for the additional member number from the home MSC, based on the obtained routing information;
if an answer indication is received regarding one of the call legs, completing the call from the home MSC to the answered leg and releasing the other one of the call legs; and
if completion to at least one of call legs is not possible, completing the call from the home MSC to an alternate termination in accord with a subscriber service record associated with the pilot number.

2. The method of claim 1, wherein the completion of the call to the alternate termination occurs in the event that the home MSC learns that the mobile station assigned the pilot number is busy.

3. The method of claim 1, wherein the completion of the call to the alternate termination occurs in the event that both call legs result in busy conditions.

4. The method of claim 1, wherein the alternate termination comprises a mailbox associated with the pilot number for the multiple alerting service.

5. The method of claim 1, which is capable of completing the call to the alternate termination in the event of each of the following conditions: busy, no answer, failed call routing, no page response, member not reachable and group not reachable.

6. The method of claim 1, wherein the second call leg is related to an attempt to reach a second mobile station.

7. The method of claim 1, wherein the step of completing the call to the alternate termination comprises obtaining a destination number for an additional member and launching another call leg for the destination number for the additional member.

8. A multiple alerting service, provided through a communication network, the service comprising the features:
a pilot number assigned for the multiple alerting service for a subscriber is a mobile number of a station of the subscriber, served by a home location register (HLR) of a home mobile communication network of the subscriber;
the service supports at least one additional multiple alerting member destination number (DN), in the subscriber's multiple alerting group;
each additional multiple alerting member DN can be a mobile DN;
each additional multiple alerting member DN can be a wireline member DN;
in response to any call to the pilot number, the mobile communication network provides simultaneous alerting signals to the mobile station and to up to a predetermined number of additional multiple alerting member DNs in the group; and
the multiple alerting service for the subscriber supports up to plurality additional multiple alerting member DNs higher in number than the predetermined number, and the HLR selects a next available multiple alerting member DN if any of the simultaneously alerted stations is busy.

9. The service as in claim 8, further comprising a voice mailbox provided in association with the pilot number, by the home mobile communication network.

10. The service as in claim 9, wherein the HLR causes the home mobile communication network to route calls to the voice mailbox upon occurrence of each of a plurality of conditions relating to an inability to complete calls to one or more stations of the group.

11. The services of claim 10, wherein the plurality of conditions comprise two or more conditions selected from the group consisting essentially of: busy condition with respect to a mobile station associated with the pilot number, busy condition with respect to all stations of the group, unreachable status of one or more of the stations of the group, and no answer by any of the stations of the group within a predetermined time interval.

12. The service of claim 8, further featuring support for distinctive alerting.

13. The service of claim 8, further comprising a capability to route a call to a voice mail service in the event that the subscriber's mobile station signals dialing of the pilot number dials, or dialing of its own number or dialing of a predetermined code.

14. A method of providing multiple alerting service through a mobile communication network, comprising:
receiving call origination signaling relating to a call for a pilot number of a multiple alerting group, at a mobile switching center (MSC) serving as a home MSC for the pilot number;
accessing a home location register record associated with the pilot number to obtain roaming location information of a mobile station assigned the pilot number and information regarding routing to at least one additional member number;
if the mobile station assigned the pilot number or a station associated with any additional member number is unavailable, providing information regarding routing to an available further member number;
supplying the resulting information regarding a plurality of numbers to the home MSC;
launching a plurality of call legs based on the resulting information, from the home MSC; and
if an answer indication is received regarding one of the call legs, completing the call from the home MSC to the answered leg and releasing the other one of the call legs.

15. The method of claim 14, further comprising if completion to at least one of call legs is not possible, completing the call from the home MSC to an alternate termination in accord with a subscriber service record associated with the pilot number.

16. The method of claim 15, wherein the alternate termination comprises a mailbox associated with the pilot number for the multiple alerting service.
